(19) United States
(12) Patent Application Publication
(10) Pub. No.: US 2006/0184393 A1
(43) Pub. Date: Aug. 17, 2006

(54) Online medical data collection

(76) Inventors: Leon H. Ewin, Mission Viejo, CA (US); Paul Hsiang, Mission Viejo, CA (US); Thomas P. Tackabery, Mission Viejo, CA (US); Derek Niehus, Mission Viejo, CA (US); Leslie Harold Davidner, Mission Viejo, CA (US); Richard E. Tackabery, Mission Viejo, CA (US)

Correspondence Address: MACPHERSON KWOK CHEN & HEID LLP, 1762 TECHNOLOGY DRIVE, SUITE 226, SAN JOSE, CA, 95110, US

(21) Appl. No.: 11/320,211

(22) Filed: Dec. 28, 2005

Related U.S. Application Data
(60) Provisional application No. 60/640,103, filed on Dec. 29, 2004.

(51) Int. Cl. G06Q 10/00

(52) U.S. Cl. 705/2

(57) ABSTRACT

A method and system for facilitating the filling out of a medical evaluation form online and/or for facilitating the reviewing of the medical information form online are disclosed. By filling out the medical information form online, the form can be filled out generally anywhere and generally any time prior to a consultation with the doctor. Assistance with the filling out process can be provided, such as by a friend or relative, without requiring that the person providing the assistance accompany the patient to the doctor's office. A doctor can review the medical evaluation form generally anywhere and generally any time prior to the consultation. On line and face-to-face medical evaluations and interactions can potentially be made safer, more efficient and of higher quality by using such a process.

### PRIORITY CLAIM

This patent application claims the benefit of the priority date of U.S. provisional patent application Ser. No. 60/640,103, filed on Dec. 29, 2004 and entitled ONLINE MEDICAL DATA COLLECTION (docket no. M-15619-V1 US) pursuant to 35 USC 119. The entire contents of this provisional patent application are hereby expressly incorporated by reference.

### TECHNICAL FIELD

The present invention relates generally to the practice of medicine. The present invention relates more particularly to a system and method for collecting medical data online.

### BACKGROUND

Medical evaluation forms for providing medical history information to health care providers are well known. Such forms are commonly filled out by a patient upon arriving at a doctor's office for an initial visit. Similar forms may be required for follow-up visits or when the doctor's office is later visited with a different complaint. They provide information to the doctor regarding the patent's medical history and present complaint.

Although such contemporary medical evaluation forms have proven generally suitable for their intended purposes, they possess inherent deficiencies that detract from their overall effectiveness and desirability. For example, since they are filled out immediately prior to a consultation, the doctor must review them immediately prior to the consultation. Medical surveys done on paper may not be comprehensive enough or may ask too many questions that do not necessarily apply to the patient's specific medical situation.

Reporting and/or recording the patient's specific answers to either a contemporary medical practitioner's face-to-face interview or via a contemporary survey are frequently, and most likely predominantly, done in an inadequate manner in terms of completeness and clarity.

Contemporary medical history taking is not the most time efficient practice. In many instances, it would be more time efficient for the doctor to review a number of such medical evaluation forms for a plurality of patients prior to beginning consultations. In this manner, the doctor avoids the inefficiencies of having to alternate between consulting with patients and reviewing medical evaluation forms. In any case, it can be more efficient for a doctor to have an opportunity to review a medical evaluation form at a time that is selected by the doctor. It would also be more efficient for the doctor to have a computer acquired initial history for one or more complaints, as well as the patient's prior medical history, to review prior to actually beginning a face-to-face or on line encounter.

Further, the review of contemporary paper forms is not as effective as desired. Such review is undesirably subject to errors. Errors can be caused by a patient's poor hand writing, by the patient's rush to complete the forms, and/or by the patient's unease of being in a healthcare setting (white coat syndrome). Errors can also be caused by a doctor simply overlooking important information. Computer acquired history reports are legible and can be formatted in such ways for easy and thorough review.

Further, it is important to obtain sufficient detail of the medical history. Oftentimes, with history obtained from paper medical evaluation forms or from face-to-face questioning sufficient information is a missing element of a patient's encounter with health care providers. Sufficient detail is missing from encounters for many reasons, including: lack of time by the physician or health care provider, lack of recall at the time of the visit, patients not being able to articulate the answers adequately, or patients not being able to give the answers to questions accurately on the spur-of-the-moment (but if given time would be able to give a more accurate response). Patients' responses to printed forms may also be limited by lack of space, regardless of the fact that many forms instruct the patient to use additional paper as needed. Thus, the risk for providing unsafe or less quality medical care may result from the lack of acquiring a medical history either from paper medical evaluation forms or even from an insufficient history taken by a medical practitioner.

Further, storage of these histories in an electronic format provides for more a secure and permanent record, as well as more efficient retrieval for review. Electronic storage allows for interfacing with various electronic health records and medical databases.

As such, although the prior art has recognized, to a limited extent, the problem of collecting medical data, the proposed solutions have, to date, been ineffective in providing a satisfactory remedy. Therefore, it is desirable to provide a means for facilitating more efficient completion and more effective review of medical evaluation forms by a doctor.

### BRIEF SUMMARY

A system and method for providing patient information to a health care provider is disclosed. According to one embodiment, the method comprises filling out a medical evaluation form online with an initial set of questions, and follow-up questions can be presented only as a result of the patient's answer to the first set. For example, the medical evaluation form can be filled out by the patient, thereby providing much more pertinent detail than from a history obtained from a medical practitioner or paper survey. The patient entry of these data potentially can spare the one obtaining the medical history, such as a doctor or triage nurse, much time for those conditions amenable to such a history taking process. Alternatively, the medical evaluation form can be filled out by someone other than the patient or in collaboration with the patient.

The medical evaluation form can be filled out prior to a doctor's visit. For example, the medical evaluation form can be filled out in a patient's home, such as via a personal computer. The medical evaluation form can similarly be filled out via a desktop computer, a laptop computer, a tablet computer, a pocket PC, a PDA, a terminal, or a telephone (including a cellular telephone). Any computer or the like can be used to fill out the form and the computer can be either wired or wireless.

Thus, a wireless device such as a wireless tablet personal computer or a personal digital assistant (PDA) can be used to fill out the online medical evaluation form. The medical evaluation form can be filled out via a telephone, including a cellular telephone. This can be done using the keypad or using voice recognition.

The medical evaluation form can be filled out in a doctor's office. Again, this can be done on a desktop computer, a laptop computer, a tablet computer, a pocket PC, a PDA, a terminal, or a telephone (including a cellular telephone). Again, any computer or the like used to fill out the form can be either wired or wireless. When the process is performed in a doctor's office, the process is generally the same as when performed elsewhere.

The electronic surveys can be used to alert a patient, based on a response to one or more questions, to seek emergent or urgent medical care. However, at other times needed care deemed from the survey responses is to be more appropriate for the doctor's office. For example, rather than instructing a patient to go immediately to a hospital in response to an answer that indicates the need for immediate medical attention, the patient can be instructed to report immediately to the office receptionist. Further, the receptionist or other personnel at the doctor's office can be notified of the patient's need for immediate medical attention.

The medical evaluation form can be suitable for patients who present with acute symptoms, chronic symptoms, chronic care needs and/or preventative care needs. Thus, a single medical evaluation form can be configured so as to fulfill a variety of different types of patient care needs.

The medical evaluation form can be configured such that it is suitable for use by a doctor for an online consultation. This can be true whether the form is intended to be filled out in the doctor's office or elsewhere. Thus, a medical practitioner can provide online consultation as appropriate with regard to the patient's needs. In many instances, the use of such online consultation can make office visits more efficient, e.g., less time consuming and more likely to result in effective treatment of the patient. In other instances, the use of such online consultation can eliminate office visits altogether, e.g., by determining that no care is necessary or by providing diagnosis and prescribing treatment online. Such a survey and on line interaction between the medical practitioner and patient may result in the guidance that it is most appropriate for the patient to have a face-to-face evaluation. Thus, these on line surveys can provide the basis on which to provide a speedy on line evaluation that may result in treatment, thereby sparing more time and cost to the patient than what would have occurred with more traditional medical care, or the advice to go to the place that can provide the most appropriate medical care.

Further, the medical evaluation form can be suitable for all levels of medical care, such as an emergency visit, an urgent visit, a non-emergency triaging, medical advice services and/or a routine visit, and even could be used during an admission to the hospital to elucidate ongoing or new conditions. Responses to questions on the medical evaluation form can be used to determine whether the visit is an emergency visit, an urgent visit, a non-emergency triaging or a routine visit. Again, if immediate care is indicated, then the patient can be instructed to see the receptionist or other person at the doctor's office (particularly if the medical evaluation form is filled out there) or to seek immediate medical care.

When the medical evaluation form is filled out in a doctor's office, then face-to-face help to complete the form can be provided. Face-to-face help can be provided in response to a request for help, such as by clicking on a request for help on the medical evaluation form. Face-to-face help can be provided in response to answers to question. For example, a response such as “I don't know” or “I need help with this question” can summon a person for face-to-face help.

Online help can be provided, whether the medical evaluation form is filled out in a doctor's office or elsewhere. Thus, regardless of where the medical evaluation form is filled out, online help can be provided.

Voice prompting can be used to help with filling out the medical evaluation form. Voice prompting can provide the questions to be answered, further information regarding the questions or potential answers, or detailed information such as information regarding symptoms, drug interactions, and medical care.

Either directed text (questions have single or multiple choice answers) or free text (the writer can type anything) can be used to answer questions. Thus, the medical evaluation form can be configured to provide either closed ended questions (such as yes/no, true/false, single or multiple choice questions) or can be configured to provide open ended questions (those that can have a much larger number of different response such as the names of illnesses or drugs). Any combination of open ended and closed ended questions can be used.

Voice recognition can be used to fill out the medical evaluation form. Voice control can be either simple or complex. Simple voice control can be used to provide responses to yes/no, true/false, single or multiple choice question (which can be answered with a letter). Complex voice control can be use to provide answers to open ended question, such as “What drugs are you allergic to?”

The medical evaluation form can be communicated to a doctor via a network, such as the Internet. For example, the medical evaluation form can be communicated to a doctor via email. Alternatively, the medical evaluation form can be communicated to a doctor via facsimile.

The medical evaluation form can be filled out via web site, such as a secure web site. The web site can use CGI scripts, Java, Active X, or any other desired method for providing questions and/or receiving answers. If filed to a secure web site, these forms would potentially be available to be accessed for use in providing medical care wherever the patient may be and so long as there is access to this Internet site.

The medical evaluation form can be printed from a computer. The printout can mimic the presentation of the medical evaluation form as it is presented on the computer or can have an altogether different appearance.

The medical evaluation form can be stored electronically for secure storage, easy retrieval, or integration into an electronic health record and other medical databases.

Some medical information can be flagged to assure review by a doctor. For example, information regarding serious or life-threatening conditions or other conditions requiring the doctor's immediate attention can be flagged. Drug interaction information can be flagged for review by a doctor or other medical practitioner. Drug contraindications can be flagged for review by a doctor or other medical practitioner. Diagnostic information can be flagged for review by a doctor or other medical practitioner. Keywords can be flagged for review by a doctor or other medical practitioner.

Questions of the medical evaluation form can be modified dynamically to better facilitate a diagnosis. Such dynamic modification of the question can be based upon the use of keywords in answers. Thus, questions can be modified dynamically to better provide a diagnosis based upon answers to single or multiple choice questions. For example, later questions in the medical evaluation form can be modified depending upon answers to earlier questions in the medical evaluation form. Follow-up questions can be presented to the patient based upon answers to prior questions. This process can be repeated to a practically infinite degree. In this manner, the patient is presented with questions that are pertinent to his or her specific medical condition and situation.

An algorithm can process answers to questions and provide a proposed diagnosis. The algorithm can be run on a general purpose computer such as a personal computer (PC). Alternatively, a state machine or custom processor can run the algorithm.

As mentioned above, medical personnel can be promptly notified when an answer to a question indicates that immediate attention is required. Further, an escalation process can be used to notify medical personnel when information has not been acted upon in a timely manner.

The information provided via the medical evaluation form can be used for preventive care. For example, the information can be used to help the doctor determine what, if any, preventative steps should be taken. The preventative steps can include medical procedures, prescription of drugs, changes in nutrition, and /or an exercise plan, for example. Thus, computer algorithms can use patient responses (such as the patient's history and/or current complaints) to the medical evaluation form to determine what, if any, preventive care should be provided to the patient. For example, if the patient's responses indicate that the patient is overweight and/or pre-diabetic, then dietary information or counseling can be provided to the patient.

The patient's history can include such information as surgical history, psychological history, family history, medication history, allergy history, dental history, social history (such as alcohol intake, substance abuse history, smoking history, marital status, past and current hobbies, employment history, living environment, and travel history), immunization history, exercise history, as well as past and present eating habits. Any history that may be pertinent to the patient's physical or mental well being can be entered.

An appointment can be scheduled online. The appointment can be for a consultation, a physical examination, a medical procedure, a follow-up visit, or for any other purpose.

Test results can be sent to a patient online. The test results can be sent directly from a testing facility or can be sent from the doctor's office. Comments on the test results can be provided by the doctor. For example, the doctor can elaborate on the results of the test, tell the patient what treatment, if any, is required, and request the scheduling of a follow-up visit, if appropriate.

Medical questions can be answered online. The medical questions can comprise questions either from the patient or from medical personnel. For example, a patient may have questions for the doctor about the seriousness of a condition, treatment options, drug interactions, contraindications, or side-affects, and/or the need for a follow-up visit. A doctor may have questions for the patient regarding the effectiveness of treatment, the presence of drug side-effects, and/or the progression of an illness.

Prescriptions can be requested and/or filled online. Prescriptions refills can be requested online. For example, a request for a refill can be sent to a doctor's office for authorization, if necessary, and then forwarded to a pharmacy where it is filled.

Information from the medical evaluation form can be used to develop demographic information. This demographic information can be maintained in a database. The demographic information can be used by pharmaceutical manufacturers, government agencies, insurance companies and the like to improve health care.

A database containing medical information can be accessed online in accordance with legal and medically acceptable standards for accessing patient information. For example, an insurance database can be accessed so as to provide medical information for the medical evaluation form. For example, information relating to prior illnesses and injuries can be added to the medical evaluation form from the medical database. Similarly, a health care provider's database can be used to provide medical information for the medical evaluation form.

Thus, information from the medical evaluation form can be stored in the database for such later use. Further, information from the medical evaluation form can be stored in a database and then subsequently checked against information added at a later time for at least one of drug interactions, drug contraindications, and diagnostic information.

Information from the medical evaluation form can be reviewed either real-time or not real-time. The information can be used for triage in real-time and can be suitable for both emergency and non-emergency use. This information, if stored in a manner amendable to internet access, can be obtained and used wherever and whenever this type of patient data is needed so long as internet access is acquirable.

A survey can be provided in a context sensitive manner. That is, questions of the survey can depend upon the context in which they are being asked. For example, if a response to the medical evaluation form indicates that the patient has allergies, then a survey can be provided to better determine what substances that patient comes into contact with that can cause an allergic response. As a further example, a response to the medical evaluation form may indicate that the patient is overweight. A survey could then be provided to determine the patient's eating and exercise habits.

Surveys can be initiated by either the patient or the medical provider depending on the information the patient wishes to convey or what information the provider wishes to obtain. For example, a patient with asthma wishes to receive input from the doctor concerning a cough, completes a survey relating to this and initiates communication to the physician for on line or future face-to-face evaluation. When received and reviewed, the doctor wishes more information about the patient's asthma and requests the survey for follow-up on asthma to be completed and returned. This is all done via electronic communication.

One language can be used for input and another language is used for output. That is, the medical evaluation form can be presented and filled out by the patient in one language and the medical evaluation form can subsequently (or in real-time) be reviewed by a doctor in another language.

The medical evaluation forms can be developed and presented to the patient based on specific characteristics of that patient, such as age, dependent status, gender, demographics or medical status. Also, medical evaluation forms can be confidentially presented to minors who are not legally emancipated for general medical care, yet emancipated by law for the purpose of obtaining medical care for certain needs, such as those relating to sexuality, behavioral health or drug addiction/rehabilitation. Thus, according to at least one embodiment of the present invention, it is possible to keep confidential these types of data for minors that patents/guardians do not have a legal right to have knowledge of without consent, while at the same time allowing the access to data of minors that can legally be accessed by parents and guardians.

Electronic acquisition of the medical evaluation form will result in the ability for a report to be generated of the patient-entered (independently or with assistance) responses. This electronically generated report can be reviewed by the medical practitioner at a convenient and/or appropriate time. Such reports can be formatted to facilitate the review of a patient's historical data in a way that makes this process extremely efficient and comprehensive. Concise and clear electronic reporting of patient entered history for the medical practitioner's review can result in a safer and higher quality of medical care.

The medical evaluation form can be reviewed first by a computer algorithm that flags responses for close review by the doctor, that proposes diagnoses, that suggest treatments, that provides prescriptions, that schedules appoints, or that does any other procedure that benefits either the doctor or the patient.

The system can comprise a server upon which the medical evaluation form, the database, and one or more application programs for controlling use of the medical evaluation form, patient responses, and the database are maintained. The server can be located at the doctor's office or at any other location. One server can provide medical evaluation forms for a plurality of different doctors or doctor's offices. Similarly, one server can provide access to the database or portions thereof for a plurality of different doctors or doctor's offices.

Optionally, a plurality of servers can be used. Each server can be redundant and can, for example, provide service for a different geographic region. Alternatively, each server can provide different functionality. For example, one server can provide the medical evaluation form to a patient, another server can translate the language of the responses to the medical evaluation form, and another server can store the responses in a database.

This invention will be more fully understood in conjunction with the following detailed description taken together with the following drawings.

### BRIEF DESCRIPTION OF THE DRAWINGS

FIG. 1 is a semi-schematic flow chart showing the filling out of a medical evaluation form by a patient at a doctor's office and the reading of the medical evaluation form by the doctor at the doctor's office, typically immediately prior to the consultation with the patent, according to contemporary practice;

FIG. 2 is a flow chart showing the process of filling out a medical evaluation form by a patient online according to an exemplary embodiment of the present invention;

FIG. 3 is a flow chart showing some optional processing of the medical evaluation form that can be done by a computer according to an exemplary embodiment of the present invention; and

FIG. 4 is a schematic view showing a server in wired communication with the Internet and showing a client computer (such as a PC) in wireless communication with the Internet, wherein the server and the client are configured to facilitate filling out a medical evaluation form online and facilitate reviewing the medical information form online.

Embodiments of the present invention and their advantages are best understood by referring to the detailed description that follows. It should be appreciated that like reference numerals are used to identify like elements illustrated in one or more of the figures.

### DETAILED DESCRIPTION OF THE PREFERRED EMBODIMENTS

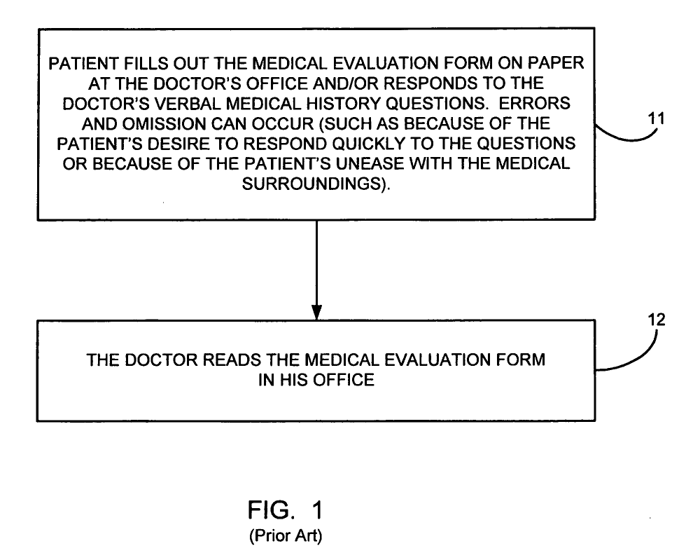

Referring now to FIG. 1, according to contemporary practice a patient fills out a medical evaluation form or responds to a doctor's medical history questions at the doctor's office, as indicated in block 11. Although the form can be filled out at home, this is frequently done at the doctor's office immediately prior to a consultation with the doctor. Therefore, the medical evaluation form is often filled out when the patent is ill, hurt, upset, nervous, in a rush, and/or in unfamiliar, intimidating surroundings. Filling out the medical evaluation form in such instances can result in inaccuracies.

Such inaccuracies can adversely affect a doctor's ability to properly treat the patient. That is such inaccuracies can inhibit the formation of an accurate diagnosis and/or can cause improper treatment to be prescribed. For example, a patient who is very concerned about his condition may forget to list an important symptom of the condition, thus leading to an incorrect diagnosis. As a further example, a patient who is in a hurry to fill out the medical evaluation form may inadvertently forget to list a drug allergy, potentially with serious consequences.

After the patient has filled out the medical evaluation form in the doctor's office, the doctor then reviews the medical evaluation form prior to the consultation, as indicated in block 12. Often, the doctor is in a hurry to begin the consultation. This can lead to the doctor misreading or overlooking something important on the medical evaluation form, potentially with serious consequences.

The process of reviewing a patient's medical evaluation form and consulting with the patient is repeated, generally for every patient that the doctor sees. This process can be inefficient and can result in errors that can adversely affect the well being of the patent.

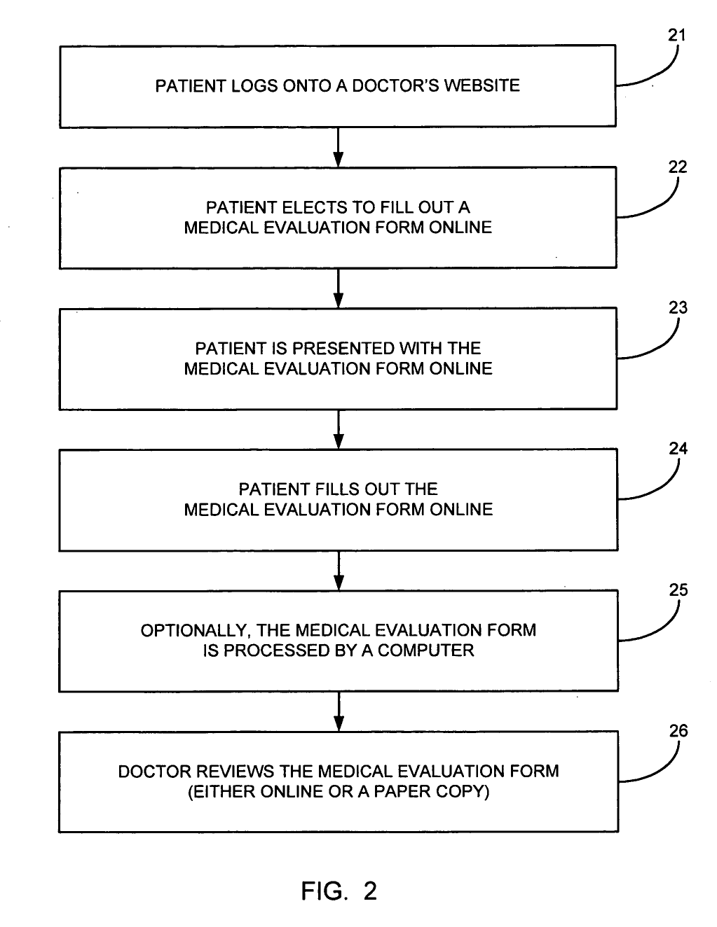

Referring now to FIG. 2, according to one or more aspects of the present invention a medical evaluation form is filled out online. For example, a patient can log onto a doctor's website as indicated in block 21. Alternatively, the patient can initiate online communication in any other desired manner. For example, the patient can access a computer terminal.

On the doctor's website, the patient elects to fill out a medical evaluation form, as indicate in block 22. The patient can elect to fill out the medical evaluation form by selecting, e.g., clicking on, text, an icon, or any other indicia that facilitates such selection. After the selection is made, the patient is presented with the medical evaluation form online, as indicated in block 23. Typically, the medical evaluation form will be displayed upon a computer screen. Alternatively, the medical evaluation form could be printed out and subsequently scanned or otherwise interfaced into a computer for communication to the doctor.

After the medical evaluation form is displayed, the patent can fill it out as indicated in block 24. The online medical evaluation form can contain questions such as those commonly found on paper medical evaluation forms. Optionally, the medical evaluation form can contain information and/or questions that are specific to the online environment. For example, one question could request the patient's email address.

Optionally, the medical evaluation form is processed by a computer, as indicated in block 25. This processing can make the information provided by the patient more useful, as discussed in detail below. The computer that performs such processing can be the computer that the patient uses to fill out the online form, a server to which the patient's computer is connected (which can be at the doctor's office or elsewhere), a computer at the doctor's offices, or any other computer.

Once the medical evaluation form has been filled out and optionally processed, the doctor can review the form as indicated in block 26. The doctor can either review the form on a computer monitor or can print the form out and review a paper copy thereof. The form can either be stored on a server, the doctor's computer, or any other computer.

By providing the medical evaluation form to the doctor well in advance of a patient's visit, the doctor has ample opportunity to review the form properly. Thus, the doctor can review the form when he or she is not seeing patients, for example. This can provide the doctor with more time to properly consider the responses on the form and any additional information provided by computer processing.

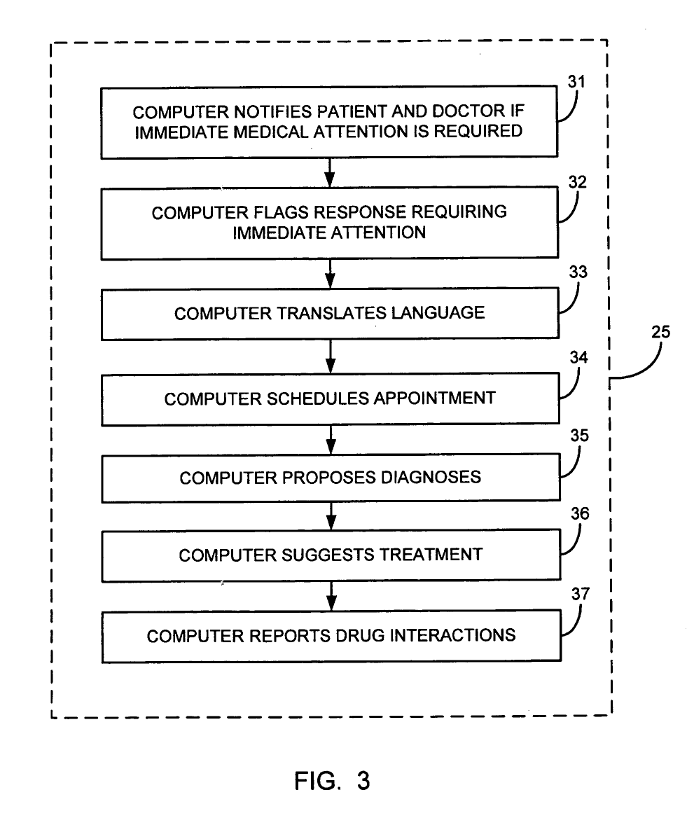

Referring now to FIG. 3, a computer can perform a variety of different processing tasks that will tend to add utility to the filled out medical evaluation form. A computer can notify the patient and/or doctor if immediate assistance is required, as indicated in block 31. Thus, if it is determined by responses to questions in the medical evaluation form that the patient has a serious medical condition requiring immediate medical care, then the patient and/or doctor can be informed.

A computer can flag any responses that require immediate attention, as indicated in block 32. These can be responses that result in the patient and/or doctor being notified that the patient should seek medical attention immediately or can be other responses. Thus, they can be responses that the doctor needs to be aware of, but that do not indicate the need for immediate medical care.

A computer can translate the language of the medical evaluation form, as indicated in block 33. Thus, the medical evaluation form can be filled out by the patient in one language and then reviewed by a doctor in another language. Both the questions and the answers can be translated. However, it will typically only be necessary to actually translate the responses, since the questions can be provided in multiple languages beforehand.

A computer can schedule an appointment for the patient with the doctor online, as indicated in block 34. The computer can manage all of the doctor's appointments or can alternatively interface with a process that does so. In this manner, the computer has access to the doctor's schedule and can thus determine when an appointment with the patient is appropriate.

A computer can propose a preliminary diagnosis for the doctor, as indicated in block 35. The computer can use responses to the medical evaluation form regarding the patient's medical history, present complaint and symptoms associated therewith, and/or current treatments to determine a possible diagnosis for the present complaint. The doctor can then be made aware of this preliminary diagnosis and can agree with it, reject it, or investigate further to determine if the preliminary diagnosis is appropriate.

The computer can suggest treatment for the patient as indicated in block 36. This treatment can be based upon the preliminary diagnosis or a subsequent diagnosis provided by the doctor. It can take into account the patient's history and physical parameters (sex, weight, age, etc.), any current treatments (such as drugs currently being taken), and drug allergies or contraindications. The doctor can review the treatment that is suggested by the computer and then either accept the suggested treatment or reject it. The doctor can also modify the suggested treatment, such as by changing drugs, doses, methods of administration, etc.

Thus, a computer can report any adverse drug interactions or other problems associated with a treatment plan, as indicated in block 37. This can be done whether or not the computer suggested the treatment plan. Thus, a treatment plan can be defined by a doctor and the computer can then use responses to the medical evaluation form to determine whether or not the treatment plan is appropriate and to report any problems therewith.

According to one aspect of the present invention, medical evaluation forms are filled out by patients online, prior to visiting a doctor's office. In this manner, the forms can generally be filled out at the patient's leisure, without undo time pressure and in a comfortable setting. With current and future wireless technology, electronic, online survey completions could conceivably be done anywhere and at anytime. Since the forms can be completed in a time that is convenient for the patient, the patient is substantially less likely to make errors.

Further, the doctor can review the medical evaluation form any time prior to the patient's consultation and can review the form from many different convenient locations. The doctor can review the medical evaluation form from home, while commuting to work (such as via a laptop computer to which the medical evaluation form was previously downloaded or via a wireless connection to the Internet).

The doctor can review the medical evaluation forms of several patients prior to consulting with these patients. This is likely to enhance the doctor's overall efficiency, as well as effectiveness. The doctor's efficiency may be enhanced by avoiding alternating between reviewing medical evaluation forms and consulting with patients, as is done according to contemporary practice, as shown in FIG. 1. The doctor's effectiveness may be enhanced by eliminating the need to rush through the medical evaluation forms so that the consultation can begin. Further, medical problems, drug contraindications, and diagnostic information can be flagged, making the review more efficient.

According to one aspect of the present invention, the medical evaluation forms are filled out by a patient or another person in the patient's home or elsewhere outside of the doctor's office. This may be done on a home computer, for example.

According to one aspect of the present invention, the medical evaluation forms are filled out at the doctor's office, such as in the lobby thereof. This may be done on a computer provided by the doctor for such use.

By having the patient, the patient's guardian, or the patient's representative fill out the medical evaluation forms prior to a visit to the doctor's office, more time and care can be taken with the consultation. Not only does this facilitate more accurate completion of the forms, but it also provides the ability to have more extensive information provided. That is, since the time pressure associated with filling out the forms at the doctor's office is eliminated, more extensive forms may be utilized and better compliance in properly filling out the forms is expected.

Face-to-face interaction with a medical profession may be provided to answer questions when the online form is being filled out in a doctor's office. Online chat may similarly be used to provide help when the forms are being filled out from a location other than the doctor's office. Voice prompting (such as via recorded voice or voice synthesis) and/or voice recognition may be used to aid in filling out the forms.

Use of the present invention assures that sufficient detail is provided in the medical evaluation forms. Thus, all of the information needed by a doctor to properly diagnose and treat a patient is more likely to be provided.

Healthcare providers are defined herein, in general, to include physicians, physician assistants, registered nurse practitioners, podiatrists, chiropractors, acupuncturists, optometrists, dentists, psychotherapists, licensed nurses or any other licensed person to provide medical care.

Doctor's visits, as discussed herein, can be health care encounters that include physician visits, but are not limited to only physician visits. For example, doctor's visits may include face-to-face encounters, online encounters, telephone encounters, or any other exchanges of information between a patient and a health care provider.

Reading a detailed medical history captured prior to the encounter, such as via the online medical data collection of the present invention, is much more efficient than acquiring it when present with the patient. The pre-evaluation history can be elaborated upon as needed once the provider is with the patient.

Surveys can be responded to in delayed or real-time. The real-time aspect is important for use in triaging. Thus, patient data entry can be reviewed within a context (e.g., as a triage, online consultation, pre-medical encounter) in a delayed or real-time manner.

Surveys can be provided in a context sensitive or specific manner. That is, they can be directed to acute, sub-acute or chronic symptoms, chronic disease states, initial presentations, follow-up visits for same symptom or condition, controlled states and uncontrolled states. For example, a different set of questions (surveys) would be used for newly diagnosed diabetic, a follow-up visit for a diabetic, a controlled diabetic's visit, an uncontrolled diabetic's visit. The surveys would ask questions and follow-up questions based on what the context is.

Triage, as the term is used herein, can include both traditional triage and the dispensing of medical advice. Thus, medical advice can be provided on a basis that depends upon the importance or need for that advice.

Optionally, the patient can designate what information from the medical evaluation form is provided to what person or company. For example, the patient can designate what information is provided to the doctor, what information is provided to the insurance company, and what information is to be maintained in a database.

A computer can use information from the medical evaluation form to define and provide to the patient strategies for the treatment of chronic illnesses and strategies for treating non-chronic medical problems such as illnesses and injuries. Such strategies can include nutrition or dietary plans, exercise plans, drug therapies, and any other types of wellness or medical information. The computer can determine medical treatment for acute and non-acute medical conditions.

One or more embodiments of the online medical data collection system of the present invention can be implemented as a secure and HIPAA (Health Information Portability and Accountability Act) compliant system, such as via a HIPAA compliant web site.

One advantage of online medical data collection according to one or more embodiments of the present invention is that someone other than the patient can more easily help the patient fill out the form or can fill out the form for the patient. For example, it is not necessary that someone accompany the patient to the doctor's office in order to provide such assistance according to the present invention.

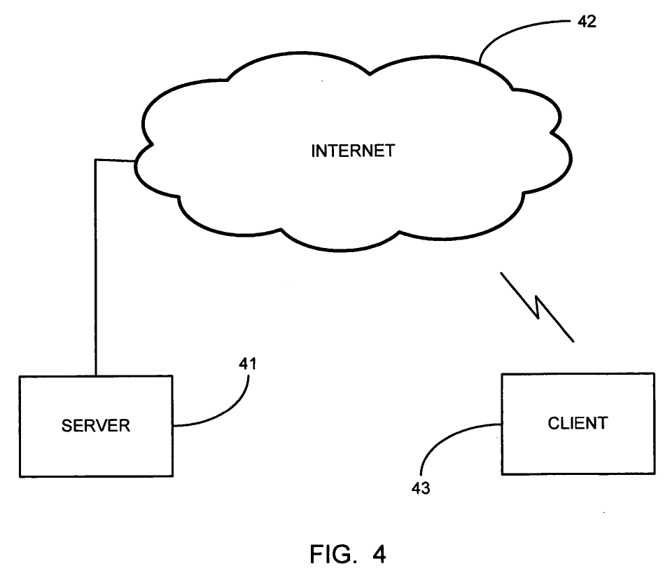

Referring now to FIG. 4, a server 41 is in communication with the Internet 42 and a client 43 is also in communication with the Internet 42. Server 41 and client 43 are configured so as to facilitate filling out a medical evaluation form online and facilitate reviewing the medical information form online. Server 41 can be in either wired (as shown) or wireless communication with the Internet 42. Similarly, client 43 can be in either wired or wireless (as shown) communication with the Internet 42.

According to one or more embodiments, the present invention facilitates the ability for an online health care provider and patient interaction that becomes a medical evaluation, with the judgment of the practitioner having a much more sound basis since a more thorough history is available according to the present invention than what occurs according to contemporary practice via a phone, email or other non-face-to-face evaluation.

Although the Internet 42 is shown in FIG. 4, any other network can alternatively be used. For example, an intranet such as a LAN or a WAN could alternatively be used. This, discussion herein regarding the use of the Internet for facilitating communication between a server and a client is by way of example only, and not by way of limitation.

Server 41 can be a personal computer (PC). Server 41 can be located at the doctor's office. Server 41 can alternatively be located remotely with respect to the doctor's office.

Client 43 can be a personal computer (PC), such as a tablet PC, a personal digital assistant (PDA) or any device capable of use in responding to answers on a medical evaluation form, as discussed above.

Software for facilitating the presentation and filling out of the medical evaluation form can be located on server 41, client 43, another computer, or any combination of server 41, client 43, and another computer. Software such as CGI Scripts, Java or Active X can be used to facilitate the presentation and/or filling out of the medical evaluation forms.

A database of responses or information related to responses to medical evaluation forms can be stored on server 41. Alternatively, the database can be stored on another computer.

Embodiments described above illustrate, but do not limit, the invention. It should also be understood that numerous modifications and variations are possible in accordance with the principles of the present invention. Accordingly, the scope of the invention is defined only by the following claims.

1. A method for providing patient information to a health care provider, the method comprising filling out a medical evaluation form online.

2. The method as recited in claim 1, wherein the medical evaluation form is filled out by the patient.

3. The method as recited in claim 1, wherein the medical evaluation form is filled out by someone other than the patient.

4. The method as recited in claim 1, wherein the medical evaluation form is filled out prior to a doctor's visit.

5. The method as recited in claim 1, wherein the medical evaluation form is filled out outside of an environment where medical care is rendered.

6. The method as recited in claim 1, wherein the medical evaluation form is filled out in a patient's home on a personnel computer.

7. The method as recited in claim 1, wherein the medical evaluation form is filled out on a wireless device.

8. The method as recited in claim 1, wherein the medical evaluation form is filled out on a wireless tablet personal computer.

9. The method as recited in claim 1, wherein the medical evaluation form is filled out on a personal digital assistant (PDA).

10. The method as recited in claim 1, wherein the medical evaluation form is filled out on a wireless personal digital assistant (PDA).

11. The method as recited in claim 1, wherein the medical evaluation form is filled out on a telephone.

12. The method as recited in claim 1, wherein the medical evaluation form is filled out on a cellular telephone.

13. The method as recited in claim 1, wherein the medical evaluation form is filled out in a doctor's office.

14. The method as recited in claim 1, wherein the medical evaluation form is filled out in a doctor's office on a computer that has been configured for this purpose.

15. The method as recited in claim 1, wherein the medical evaluation form is suitable for patients who present with at least one of acute symptoms, chronic symptoms, chronic care needs and preventative care needs.

16. The method as recited in claim 1, wherein the medical evaluation form is suitable for use by a doctor for an online consultation.

17. The method as recited in claim 1, wherein the medical evaluation form is suitable for at least one of an emergency visit, an urgent visit, non-emergency triaging, medical advice services, conditions arising during hospital admissions and a routine visit.

18. The method as recited in claim 1, wherein the medical evaluation form is filled out in a doctor's office and face-to-face help is provided.

19. The method as recited in claim 1, wherein the medical evaluation form is filled out somewhere other than in a doctor's office and online help is provided.

20. The method as recited in claim 1, wherein voice prompting is used to help with filling out the medical evaluation form.

21. The method as recited in claim 1, wherein voice recognition is used to fill out the medical evaluation form.

22. The method as recited in claim 1, wherein directed text (questions have single or multiple choice answers) is used to answer questions.

23. The method as recited in claim 1, wherein free text (the writer can type anything) is used to answer questions.

24. The method as recited in claim 1, wherein the medical evaluation form is communicated to a doctor via a network.

25. The method as recited in claim 1, wherein the medical evaluation form is communicated to a doctor via the Internet.

26. The method as recited in claim 1, wherein the medical evaluation form is communicated to a doctor via facsimile.

27. The method as recited in claim 1, wherein the medical evaluation form is communicated to a doctor via mail.

28. The method as recited in claim 1, wherein the medical evaluation form is filled out via a secure web site.

29. The method as recited in claim 1, wherein the medical evaluation form is printed from a computer.

30. The method as recited in claim 1, wherein some medical information is flagged to assure review by a doctor.

31. The method as recited in claim 1, wherein drug interaction information is flagged for review by a doctor.

32. The method as recited in claim 1, wherein drug contraindications are flagged for review by a doctor.

33. The method as recited in claim 1, wherein diagnostic information is flagged for review by a doctor.

34. The method as recited in claim 1, wherein keywords are flagged for review by a doctor.

35. The method as recited in claim 1, wherein questions are modified dynamically to better facilitate a diagnosis.

36. The method as recited in claim 1, wherein questions are modified dynamically to better facilitate a diagnosis, dynamic modification being based upon the use of keywords in answers.

37. The method as recited in claim 1, wherein questions are modified dynamically to better provide a diagnosis based upon answers to questions.

38. The method as recited in claim 1, wherein an algorithm processes answers to questions and provides a proposed diagnosis.

39. The method as recited in claim 1, further comprising notifying medical personnel promptly when an answer to a question indicates that immediate attention is required.

40. The method as recited in claim 1, further comprising using an escalation process to notify medical personnel when information has not been acted upon in a timely manner.

41. The method as recited in claim 1, wherein the information is used for preventive care.

42. The method as recited in claim 1, further comprising scheduling an appointment online.

43. The method as recited in claim 1, further comprising sending test result to a patient online.

44. The method as recited in claim 1, further comprising answering medical questions online.

45. The method as recited in claim 1, further comprising requesting/filling prescriptions online.

46. The method as recited in claim 1, further comprising using information from the medical evaluation form to develop demographic information.

47. The method as recited in claim 1, further comprising accessing a database to provide medical information.

48. The method as recited in claim 1, further comprising accessing an insurance database to provide medical information for the medical evaluation form.

49. The method as recited in claim 1, further comprising accessing a health care provider's database to provide medical information for the medical evaluation form.

50. The method as recited in claim 1, further comprising using information from the medical evaluation form for triage.

51. The method as recited in claim 1, further comprising storing information from the medical evaluation form in a database.

52. The method as recited in claim 1, further comprising storing in a database medical information to be interfaced to other medical databases and/or electronic health records

53. The method as recited in claim 1, further comprising storing information from the medical evaluation form in a database and checking information added at a later time against the information stored in the database for at least one of drug interactions, drug contraindications, diagnostic information and other historical medical information.

54. The method as recited in claim 1, wherein the information is reviewed real-time.

55. The method as recited in claim 1, wherein the information is not reviewed real-time.

56. The method as recited in claim 1, wherein the information is used for triage in real-time and is suitable for both emergency and non-emergency use.

57. The method as recited in claim 1, wherein a survey is provided in a context sensitive manner.

58. The method as recited in claim 1, wherein a survey is confidentially completed by a legal proxy or by a minor considered to be emancipated for conditions the survey relates to.

59. The method as recited in claim 1, wherein one language is used for input and another language is used for output.

60. A method for reviewing medical evaluation forms, the method comprising reviewing the medical information forms that have been filled out online.

61. An online medical data collection system comprising a server and a client configured to facilitate filling out a medical evaluation form online and facilitate reviewing the medical information form online.
